(19) United States
(12) Patent Application Publication
(10) Pub. No.: US 2010/0269763 A1
(43) Pub. Date: Oct. 28, 2010

(54) Multi-compartment sleeved pouch

(76) Inventor: Elizabeth Kraft, Denver, CO (US)

Correspondence Address: THOMAS C. NABER, 7407 EAST NICHOLS PLACE, CENTENNIAL, CO, 80112-3206, US

(21) Appl. No.: 12/799,318

(22) Filed: Apr. 22, 2010

Related U.S. Application Data
(60) Provisional application No. 61/214,789, filed on Apr. 28, 2009.

(51) Int. Cl. A01K 27/00; B65D 30/22

(52) U.S. Cl. 119/795; 383/38

(57) ABSTRACT

A multi-compartment sleeved pouch comprising at least a first compartment having an opening thereto and an exclusive first wall, and a second compartment having an opening thereto and an exclusive second wall. The walls are independent of each other, with a portion of each wall juxtaposed and attached to each other along two opposing parallel borders thereof to thereby provide a sleeve passage between the first and second compartments. A connector can extend from the pouch for securement to an independent object. Also included in combination with the pouch is a pet restraining device such as a leash disposed through the sleeve passage and connected to a hand grip of the leash.

### CROSS-REFERENCE TO RELATED APPLICATIONS

This application claims the filing date of U.S. Provisional Patent Application Ser. No. 61/214,789, filed Apr. 28, 2009.

### STATEMENT RE: FEDERALLY SPONSORED RESEARCH/DEVELOPMENT

Not Applicable

### BACKGROUND OF THE INVENTION

The present invention relates in general to carryable pouches, and in particular to a multi-compartment sleeved pouch wherein a sleeve passage resides between at least two compartments thereof.

While prior-art hand-holdable pouches are readily available for housing various items, such pouches generally do not provide multiple exclusive and individually walled compartments independent of each other and each independently exteriorly accessible to thereby provide efficient separation of items housed in respective compartments. Additionally, prior-art pouches generally are fully unitized without integral openings allowing passage there through for a pouch-retention apparatus. As a result, such pouches must be handheld, placed in a pocket, or the like, and are not equipped to engage a site away from a user.

In view of these hindrances found in prior-art pouches, it is apparent that a need is present for a multi-compartment pouch having fully independent exteriorly-accessible compartments, and such is an object of the present invention.

Yet another object of the present invention is to provide a multi-compartment sleeved pouch whereby a sleeve is disposed between the independent compartments such that a passage is created through which a pouch retention apparatus can pass.

These and other objects of the present invention will become apparent throughout the description thereof which now follows.

### SUMMARY OF THE INVENTION

The present invention is a multi-compartment sleeved pouch for carrying items separate from each other and engageable with a retention apparatus which can extend through said sleeve of the pouch. The pouch comprises at least a first compartment having an opening thereto and an exclusive first wall, and a second compartment having an opening thereto and an exclusive second wall. The first and second walls are independent of each other, while a portion of the first wall and a portion of the second wall are juxtaposed and attached to each other along two opposing parallel borders thereof to thereby provide a sleeve passage between the compartments. The openings to the compartments are situated away from the juxtaposed wall portions, and are provided with respective closures which can be selected from the group consisting of a zipper and a hook-and-loop flap wherein such flap is engageable with the wall of the compartment with which it is associated. Material for constructing the walls can be cloth, liquid-proof material such as plastic, or any other suitable material as may be required for a specific pouch use. The pouch can additionally include a connector extending therefrom for securement to an independent object.

The present invention additionally comprises a pet restraining device comprising the above-described multi-compartment sleeved pouch and a leash having a first end connectable to a pet collar, a second end having a hand grip, and a body portion therebetween. The body portion passes through the sleeve passage such that the multi-compartment pouch is disposed on a segment of the body portion. When the pouch additionally includes a connector extending therefrom, one non-limiting use of the connector can be to attach the connector to the hand grip of the leash to thereby retain the pouch near the top of the leash. In this embodiment, potentially one compartment of the pouch can carry disposable pet-waste collector bags while another compartment can carry keys, money, identification information, and the like, thereby enabling a pet walker to maintain necessary items within easy reach while walking the pet. As is apparent, use of the here described multi-compartment sleeved pouch is not limited in any way to pet leashes, but can be disposed on any structure having at least a portion thereof retainable within the sleeve passage.

### BRIEF SUMMARY OF THE DRAWINGS

An illustrative and presently preferred embodiment of the invention is shown in the accompanying drawings in which:

FIG. 1 is a side perspective view of a two-compartment sleeved pouch disposed on a pet leash, said pouch having extending therefrom a connector engaged with a hand grip of the leash; and

FIG. 2 is an end perspective view of the two-compartment sleeved pouch and leash of FIG. 1.

### DETAILED DESCRIPTION OF THE INVENTION

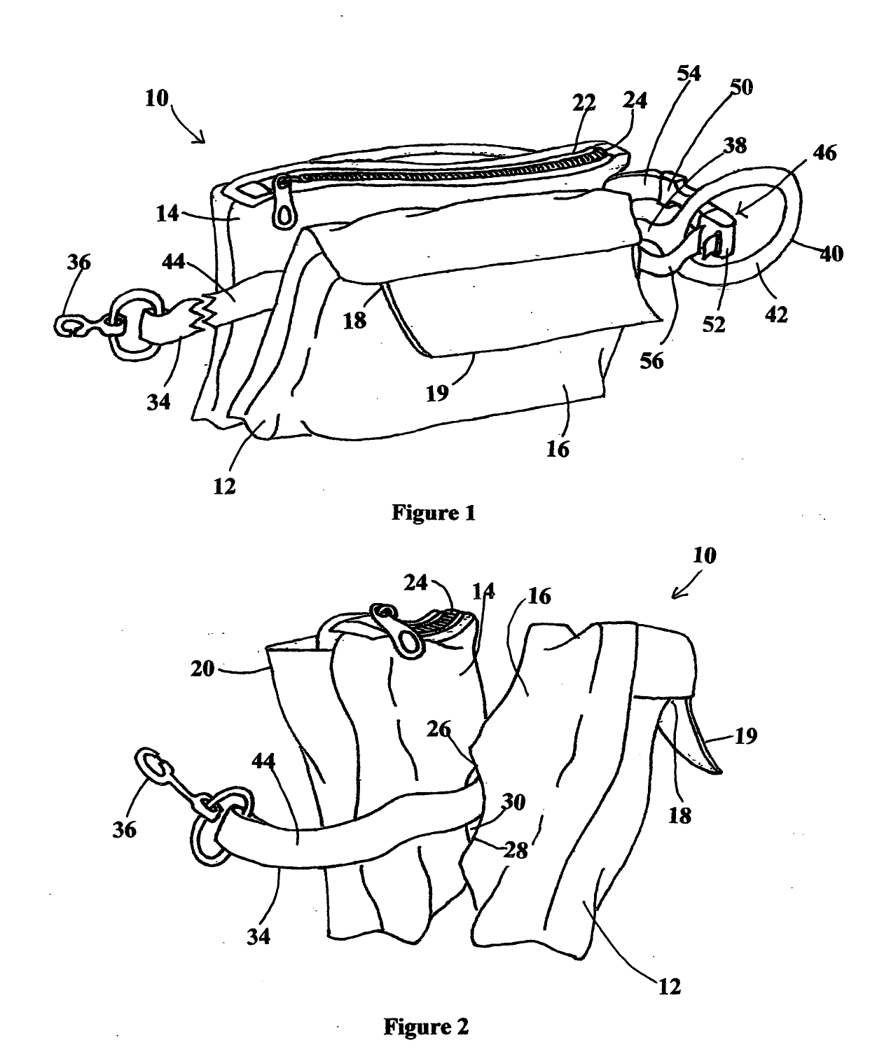

FIGS. 1 and 2 illustrates a multi-compartment sleeved pouch 10 having a first compartment 12 and an opposing second compartment 14. The first compartment 12 has an exclusive first wall 16 with an opening 18, while the second compartment 14 has an exclusive second wall 20 with an opening 22. Compartments 12, 14 can be identical or different in size and capacities. The opening 18 is here non-limitedly provided with a flap 19 releasably securable to the first wall 16 with hook-and-loop engagement (not shown) as known in the art for opening and closing the opening 18, while the opening 22 is here non-limitedly provided with a zipper 24 for opening and closing the opening 22. Each wall 16, 20 is structurally independent of the other. A portion of the first wall 16 and a portion of the second wall 20 are juxtaposed and attached to each other along two opposing parallel borders 26, 28 thereof. Such attachment can be permanent as by sewing or otherwise attaching the borders 26, 28 (FIG. 2) as here non-limitedly shown, or can be non-limitedly temporary as with male/female snap attachments or other such releasable attachment apparatus as known in the art.

Referring now to FIG. 2, the attached parallel borders 26, 28 of the compartments 12, 14 of the pouch 10 are shown to thereby provide a sleeve passage 30 between the first and second compartments 12, 14 such that an independent object of a size able to pass through the sleeve passage 30 can be so disposed. Such independent object non-limitedly can be a pet restraining device as shown in FIGS. 1 and 2 as a leash 34 having a first end 36 connectable to a pet collar (not shown), a second end 38 having a hand grip 40 here non-limitedly shown as a hand loop 42, and a body portion 44 between the first and second ends 36, 38. The body portion 44 passes through the sleeve passage 30 to thereby dispose the multi-compartment pouch 10 on a segment of the body portion 44. A connector 46, here non-limitedly illustrated as a male/female snap attachment, is secured by conventional means and here non-limitedly exemplified as comprised of opposing male and female connection clips 50, 52 each extending from respective straps 54, 56 for engageability of the opposing male and female connection clips 50, 52 to each other when the straps are disposed to surround the independent object here non-limitedly illustrated as the hand grip loop 42. When so secured to the loop 40, the pouch 10 is held in place near the second end 38 of the leash 34 for easy reach by a pet walker employing the pet restraining device.

While an illustrative and presently preferred embodiment of the invention has been described in detail herein, it is to be understood that the inventive concepts may be otherwise variously embodied and employed and that the appended claims are intended to be construed to include such variations except insofar as limited by prior art.

What is claimed is:

1. A multi-compartment sleeved pouch comprising at least a first compartment having an opening thereto and an exclusive first wall, and a second compartment having an opening thereto and an exclusive second wall, wherein said walls are structurally independent of each other and wherein a portion of the first wall and a portion of the second wall are juxtaposed and attached to each other along two opposing parallel borders thereof to thereby provide a sleeve passage between said first and second compartments, with said openings of said compartments situated away from said juxtaposed wall portions.

2. A multi-compartment sleeved pouch as claimed in claim 1 additionally comprising a connector extending therefrom for securement to an independent object.

3. A multi-compartment sleeved pouch as claimed in claim 2 wherein the connector is comprised of opposing male and female connection clips each extending from respective straps for engageability of said opposing male and female connection clips to each other upon said straps being disposed to surround the independent object.

4. A multi-compartment sleeved pouch as claimed in claim 1 wherein said first and second openings are provided with respective closures selected from the group consisting of a zipper and a hook-and-loop flap, said flap engageable with the wall of the compartment with which said flap is associated.

5. A pet restraining device comprising:
a. multi-compartment sleeved pouch comprising at least a first compartment having an opening thereto and an exclusive first wall, and a second compartment having an opening thereto and an exclusive second wall, wherein said walls are structurally independent of each other and wherein a portion of the first wall and a portion of the second wall are juxtaposed and attached to each other along two opposing parallel borders thereof to thereby provide a sleeve passage between said first and second compartments, with said openings of said compartments situated away from said juxtaposed wall portions; and
b. a leash having a first end connectable to a pet collar, a second end having a hand grip, and a body portion between said first and second ends, said body portion passing through said sleeve passage whereby the multi-compartment pouch is disposed on a segment of said body portion.

6. A pet restraining device as claimed in claim 5 additionally comprising a connector extending from the multi-compartment sleeved pouch for securement to an independent object.

7. A pet restraining device as claimed in claim 6 wherein the connector wherein the connector is comprised of opposing male and female connection clips each extending from respective straps for engageability of said opposing male and female connection clips to each other and to thereby releasably permit said straps to surround and secure said hand grip of said leash.
